(19) United States
(12) Patent Application Publication
(10) Pub. No.: US 2005/0259540 A1
(43) Pub. Date: Nov. 24, 2005

(54) Optical power adjusting tool

(75) Inventors: Cheng-Fu Lee, Taipei (TW); Yao-Te Huang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/131,178

(22) Filed: May 18, 2005

(30) Foreign Application Priority Data
May 18, 2004 (TW) 93114002

(51) Int. Cl. G11B 7/00

(52) U.S. Cl. 369/53.1; 369/116

(57) ABSTRACT

An optical power adjusting tool is movably disposed on a disk drive main body of a DVD recorder to adjust the DVD recorder. The disk drive main body has an optical pick-up head for emitting laser on a disc for recording data. The optical power adjusting tool includes a frame, a position device for positioning the frame onto the disk drive main body, and a light sensor disposed on the frame. When the optical power adjusting tool is disposed on a disk drive main body, the light sensor, being opposite to the optical pick-up head, receives an optical power of the light emitted by the optical pick-up head and produces an electric signal to adjust the DVD recorder according to the electric signal.

This application claims the benefit of Taiwan application Serial No. 93114002, filed May 18, 2004, the subject matter of which is incorporated herein by reference.

### BACKGROUND OF THE INVENTION

1. Field of the Invention

The invention relates in general to an optical power adjusting tool, and more particularly to an optical power adjusting tool applied to DVD recorders.

2. Description of the Related Art

DVD recorder (DVR) has become popular in the markets with the advanced development of the DVD-R/W(Digital Versatile Disc Recordable/Re-Writeable) and DVD players. The DVD recorder not only can invert a video with VHS (video home system) into electrical files in a CD-R (Compact Disk-Recordable), CD-RW, DVD-R, or DVD-R/W, but also can record a TV program at real time or in advance into a CD-R, CD-RW, DVD-R, or DVD-R/W.

Conventionally, the DVD player with a recording function is usually attained by integrating a DVD recorder. In order to make the DVD player operates normally, it is necessary to adjust the optical power of the DVD player via an optical power adjusting tool.

However, the conventional optical power adjusting tool is only applied to an individual DVD recorder, but fails to be applied to a DVD player with a built-in DVD recorder. Also, the DVD recorder has to be connected with a computer so that the adjusting operation can be processed and controlled by the computer. Therefore, one approach is that before the DVD recorder is disposed in the DVD player, the adjusting operation is done. But it will cause great correct error of the optical power because the entirety of the DVD player cannot be adjusted by a conventional optical power adjusting tool.

### SUMMARY OF THE INVENTION

It is therefore an object of the invention to provide an optical power adjusting tool capable of directly adjusting a DVD recorder integrated in a DVD player so that the higher accuracy of adjustment can be improved.

The invention achieves the above-identified object by providing an optical power adjusting tool is movably disposed on a disk drive main body of a DVD recorder to adjust the DVD recorder. The disk drive main body has an optical pick-up head for emitting light into a disc for recording data. The optical power adjusting tool includes a frame, a position device for positioning the frame onto the disk drive main body, and a light sensor disposed on the frame. When the optical power adjusting tool is disposed on a disk drive main body, the light sensor, being opposite to the optical pick-up head, receives an optical power of the light emitted by the optical pick-up head and produces an electric signal to adjust the DVD recorder according to the electric signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a bottom perspective view of an optical power adjusting tool according to a preferred embodiment of the invention.

FIG. 1B is a top perspective view of an optical power adjusting tool according to the preferred embodiment of the invention.

FIG. 2 is a schematic diagram of a disc recording device capable of being integrated into a DVD player.

FIG. 3 is a block diagram showing the relationship of the DVD player and the optical power adjusting tool.

FIG. 4 is a block diagram showing parts of the DVD player.

FIGS. 5A to 5C are schematic diagrams showing the operation of the optical power tool on the DVD player.

### DETAILED DESCRIPTION OF THE INVENTION

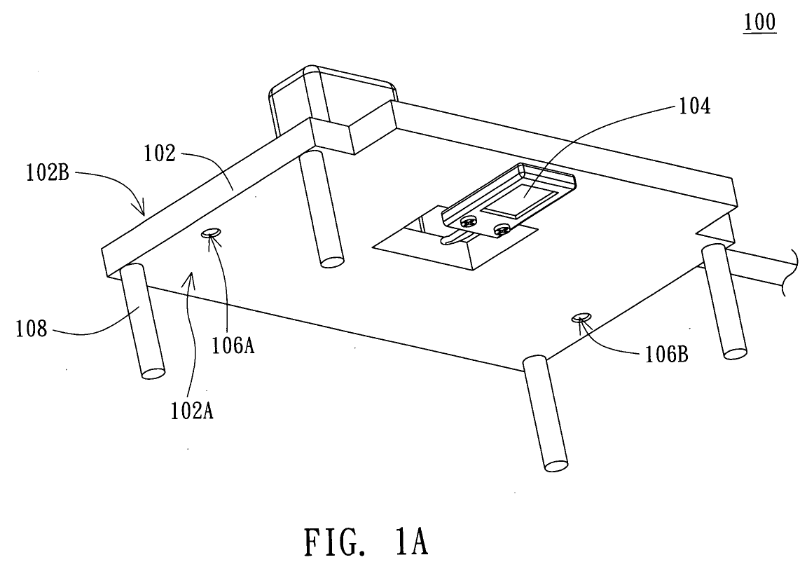

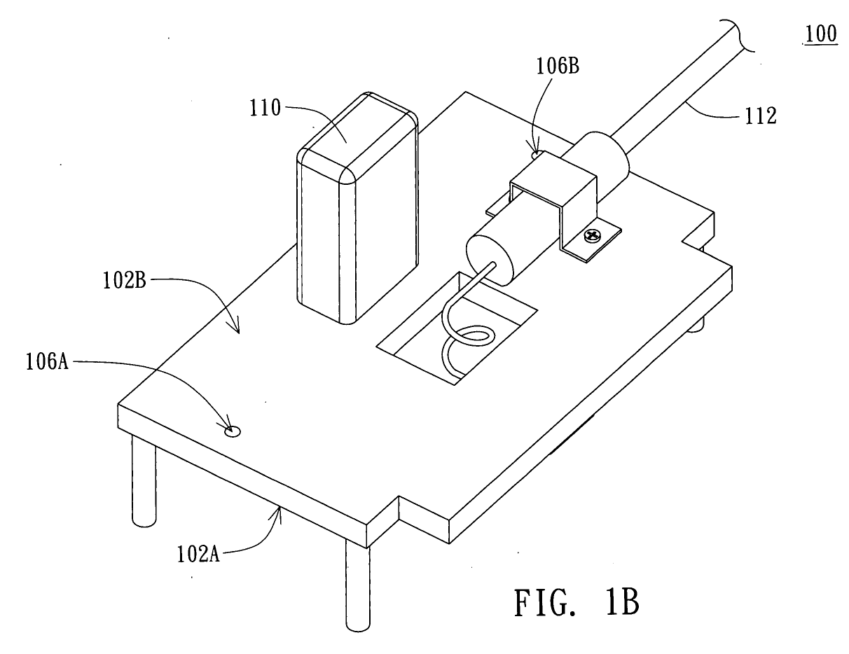

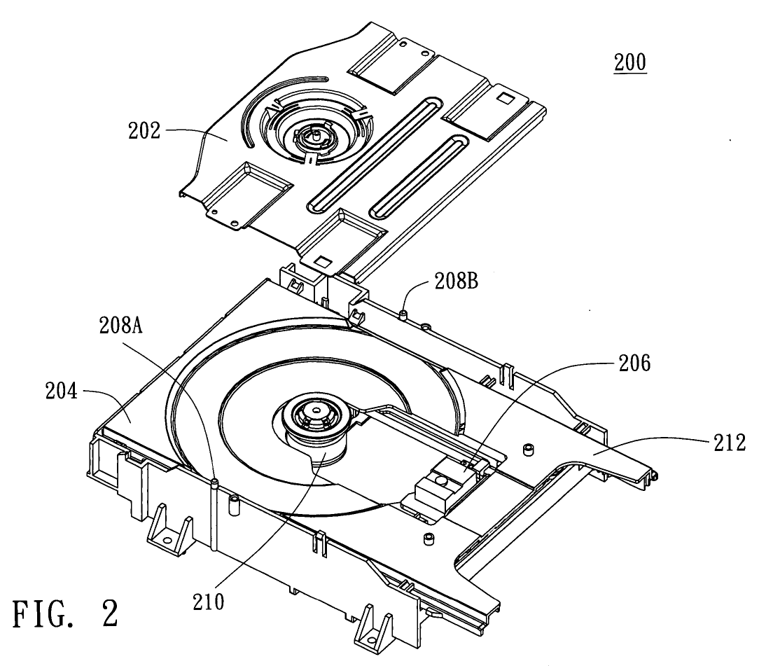

Referring to FIGS. 1A, 1B and 2, FIGS. 1A and 1B are respectively a bottom perspective view and a top perspective view of an optical power adjusting tool according to a preferred embodiment of the invention, and FIG. 2 is a schematic diagram of a disc recording device 200, capable of being integrated into a DVD player, such as a DVD recorder or a VCD (Video Compact Disc) recorder. The disc recording device 200 includes a cover 202 and a disk drive main body 204. An optical power adjusting tool 100 of the present invention includes a frame 102, a position device, and a light sensor 104. The position device is for positioning the frame 102 onto the disk drive main body 204. The position device preferably includes a first position hole 106A and a second position hole 106B formed on the frame 102. The light sensor 104 is disposed on the frame 102, and the light sensor 104 is opposite to the optical pick-up head 206 when the optical power adjusting tool 100 is disposed on the disk drive main body 204.

Further, the optical power adjusting tool 100 includes several supporting posts 108 connected on a lower surface 102A of the frame 102, a handle 110 and a conducting wire 112. The handle 110 is disposed on a top surface 102B of the frame 102 for allowing users to hold and grip the optical power adjusting tool 100 easily. The conducting wire 112 is electrically connected with the light sensor 104 for transmitting an electric signal produced by the light sensor 104. Also, the disk drive main body 204 further includes a tray 212, a spindle motor 210, a first pillar 208A and a second pillar 208B. The tray 212 can hold the disc, the spindle motor 210 is for driving the disc to rotate, and the first pillar 208A and the second pillar 208B are formed on both sides of the disk drive main body 204.

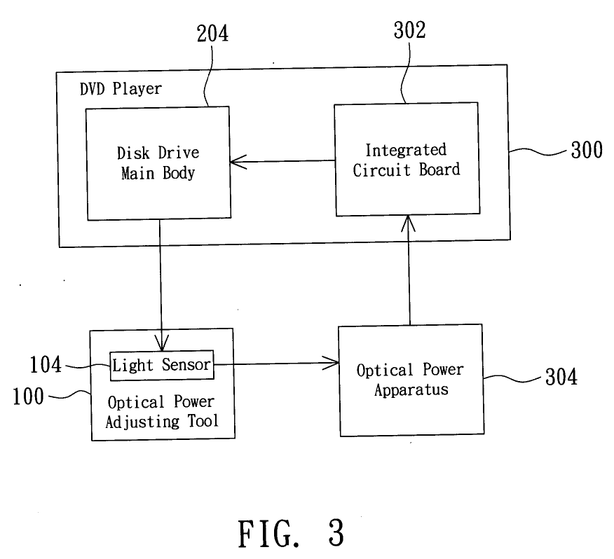

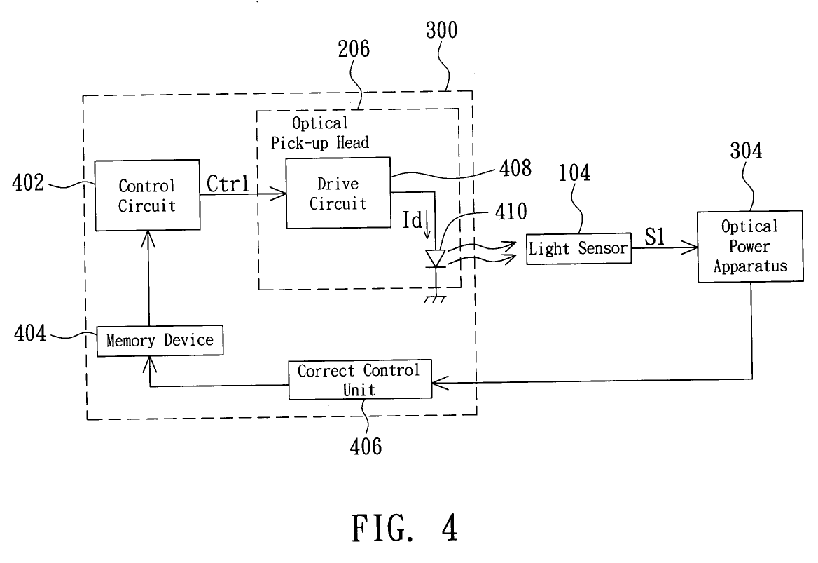

Referring both to FIGS. 3 and 4, FIG. 3 is a block diagram showing the relationship of the DVD player 300 and the optical power adjusting tool 100, and FIG. 4 is a block diagram showing parts of the DVD player 300. The DVD player 300 includes not only the disk drive main body 204, bust also an integrated circuit board 302. The integrated circuit board 302 has at least one control circuit 402, a memory device 404, and a correct control unit 406. Also, the optical pick-up head 206 of the disk drive main body 204 has at least one drive circuit 408 and a laser diode 410.

The memory device 404 keeps a record of the relationship between the electric current across the laser diode 410 (or the voltage across the laser diode 410) and an optical power produced by the laser diode 410. In other words, the memory device 404 can read the related values showing the electric current across the laser diode 410 when the laser diode 410 produces some particular optical power. When the control circuit 402 receives an original value recorded by the memory device 404, the control circuit 402 outputs a control signal “Ctrl” to the drive circuits 408 and the drive circuits 408 outputs an electric current “Id” related to the original value to the laser diode 410 so that the laser diode 410 starts to emit laser with an original optical power.

Because the original optical power and the designated optical power may not be completely the same, it is necessary to adjust the values recorded by the memory device 404 in order to change the electric current across the laser diode 410 (the voltage across the laser diode 410) and thereby the laser diode 410 can produce the designated optical power. After the adjusting operation, the adjusted value will replace the original value and be kept in the memory device 404. Therefore, the control circuit 402 will receive the adjusted value instead of the original value by the memory device 404 and outputs a control signal “Ctrl” to the drive circuits 408. And then, the drive circuits 408 outputs an electric current “Id” related to the adjusted value to the laser diode 410 so that the laser diode 410 can produce the designated optical power.

When the optical power of DVD player 300 is going to be adjusted, the optical power adjusting tool 100 has to be disposed on the disk drive main body 204 firstly to make the light sensor 104 receive the optical power produced by the laser diode 410 of the optical pick-up head 206 so that the light sensor 104 can produces an electric signal “Si” to adjust the DVD player 300 according to the electric signal “S1”.

The adjusting operation of the DVD player 300 will be further described in detail as below. When one particular optical power would be adjusted, the control circuit 402 will receive the original value recorded in the memory device 404 and make the laser diode 410 to emit laser with an original optical power. After the light sensor 104 received the laser, the electric signal “S1” is produced by the light sensor 104 and is outputted into an optical power meter 304 for outputting an original value corresponding to the original optical power into the correct control unit 406. The correct control unit 406 determines if the original optical power is substantially same to the pre-required particular optical power according to the original value received. If the original optical power is substantially same to the pre-required particular optical power, the adjusting operation will be continued to be accomplished. Otherwise, if the original optical power is not substantially same to the pre-required particular optical power, the correct control unit 406 adjusts the original values recorded in the memory device 404 again and repeat other above-mentioned steps until the optical power produced by the laser diode 410 is equal to the particular optical power.

For the DVD player 300, the integrated circuit board 302 includes not only the control circuit 402, the memory device 404, and the correct control unit 406, but also a motor servo control circuit required by the disc recording device 200, a MPEG encode/decode circuit and a record control circuit for controlling the entirety of the DVD player 300. As a result, the occupied space all components can be decreased. However, the above mentioned motor servo control circuit and the MPEG encode/decode circuit/ can also be disposed on another circuit board under the disc recording device 200.

Further, the firmware required during the adjusting operation can be stored in the correct control unit 406 or the optical power meter 304. Once the correct control unit 406 is triggered, the adjusting operation starts and the DVD player 300 can be adjusted without being connected with a computer.

When the DVD player 300 is adjusted by using the optical power adjusting tool 100 of the present invention, all influences made by the components on the integrated circuit board 302 upon the laser diode 410 can be compensated by the optical power operation because the disc recording device 200 is integrated into the DVD player 300. Therefore, the optical power adjusting tool can directly adjust a DVD recorder which is integrated in the DVD player 300, so that the higher accuracy of adjustment can be achieved as compared to the conventional adjusting operation.

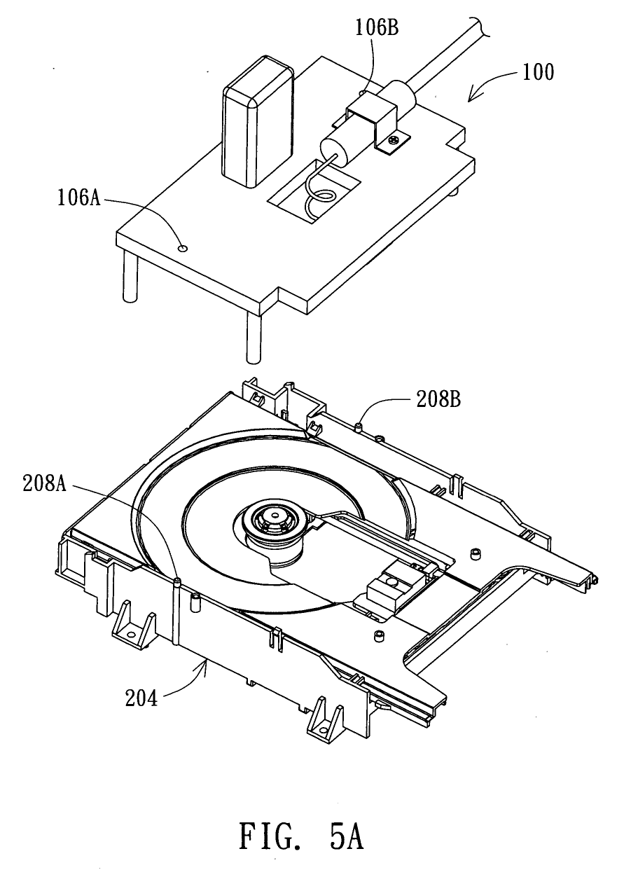

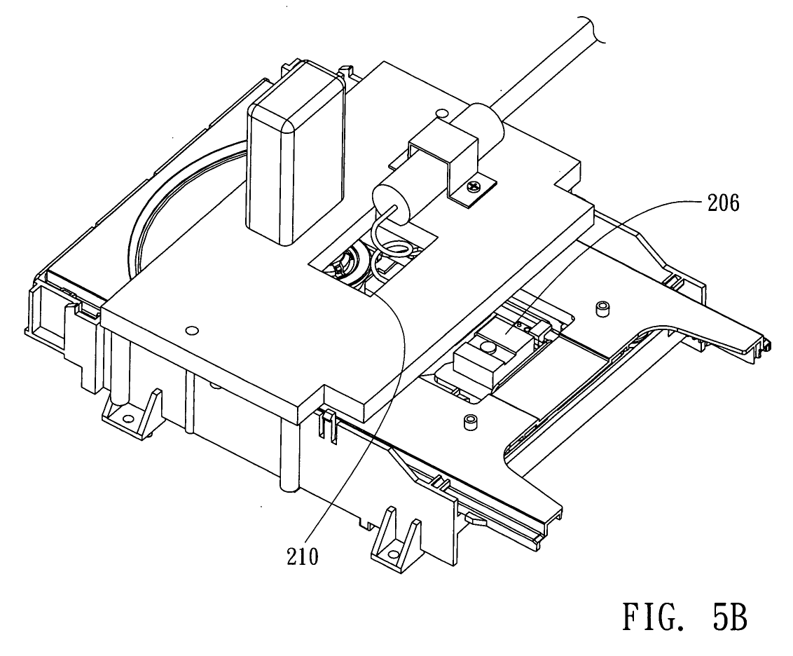

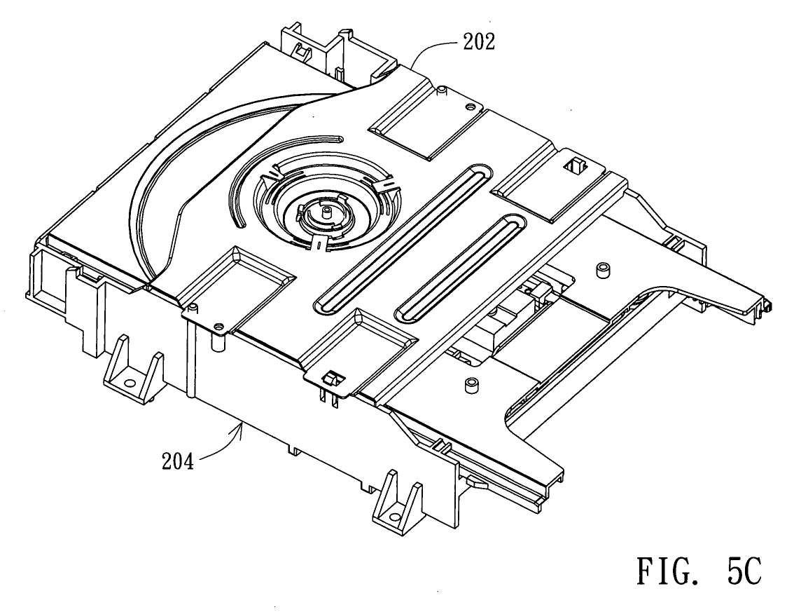

Refer to FIGS. 5A to 5C, which are schematic diagrams showing the operation of the optical power tool 100 to the DVD player 300. For clearly explanation, the entirety of the DVD player 300 is not shown in FIGS. 5A to 5C, and only the optical power adjusting tool 100 and the disk drive main body 204 are present. At first, the cover 202 is taken apart from the disk drive main body 204, as shown in FIG. 5A. Next, the optical power adjusting tool 100 of present invention is disposed on the disk drive main body 204. The first pillar 208A and the second pillar 208B are respectively received within the first position hole 106A and the second position hole 106B when the optical power adjusting tool 100 is disposed on the disk drive main body 204, so that the optical power adjusting tool 100 can be fixed and positioned onto the disk drive main body 204, followed by the adjusting operation.

During the adjusting operation, the optical pick-up head 206 preferably locates at the most inner side or the most outer side among the movable scope of the optical pick-up head 206 so that the optical pick-up head 206 can be controlled more easily and positioned more accurately; thereby decreasing the correct value. For example, the optical pick-up head 206 locates at the most outer side, as shown in FIG. 5B.

When the optical pick-up head 206 locates at the most outer side, the optical pick-up head 206 is farthest from the spindle motor 210. The light sensor 104 is disposed on the lower surface 102A of the frame 102 and is corresponding to a location where the optical pick-up head 206 is farthest from the spindle motor 210.

On the other hand, when the optical pick-up head 206 locates at the most inner side, the optical pick-up head 206 is closest to the spindle motor 210. The light sensor 104 is disposed on the lower surface 102A of the frame 102 and is corresponding to a location where the optical pick-up head 206 is closest to the spindle motor 210.

After the adjusting operation is accomplished, the optical power adjusting tool 100 of the present invention can be taken apart from the disk drive main body 204 and the cover 202 can be installed back to the disk drive main body 204, as shown in FIG. 5C. Then, the DVD player 300 starts to function. Further, the optical power adjusting tool 100 removed from the disk drive main body 204 can be disposed on a desk or a flat surface via several supporting posts 108 connected on the lower surface 102A of the frame 103. The supporting posts 108 can protect the light sensor 104 from damage.

To sum up, the optical power adjusting tool 100 of the present invention with a simple structure design can be applied to various DVD player manufacturing factories or repair offices around the world. Because the optical power adjusting tool 100 can directly adjust a DVD recorder integrated in the DVD player, so that the higher accuracy of adjustment can be achieved comparing to the conventional adjusting operation.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical power adjusting tool movably disposed on a disk drive main body of a DVD recorder to adjust the DVD recorder, the disk drive main body having an optical pick-up head for emitting laser on a disc for recording data, the adjusting tool comprising:
a frame;
a position device for positioning the frame onto the disk drive main body; and
a light sensor disposed on the frame and being opposite to the optical pick-up head when the optical power adjusting tool is disposed on the disk drive main body;
wherein the light sensor receives an optical power of the light emitted by the optical pick-up head and produces an electric signal to adjust the DVD recorder according to the electric signal.

2. The optical power adjusting tool according to claim 1, wherein the position device comprises a first position hole and a second position hole formed on the frame, and a first pillar and a second pillar formed on both sides of the disk drive main body and respectively received within the first position hole and the second position hole when the optical power adjusting tool is disposed on the disk drive main body.

3. The optical power adjusting tool according to claim 1 further comprising a plurality of supporting posts connected on a lower surface of the frame.

4. The optical power adjusting tool according to claim 1, wherein the optical power adjusting tool further comprises a handle disposed on a top surface of the frame for allowing users to hold and grip the optical power adjusting tool easily.

5. The optical power adjusting tool according to claim 1 further comprising a conducting wire being electrically connected with the light sensor for transmitting the electric signal.

6. The optical power adjusting tool according to claim 1, wherein the disk drive main body comprises a spindle motor for driving the disc to rotate, and the light sensor is disposed on a lower surface of the frame and is corresponding to a location where the optical pick-up head is closest to the spindle motor.

7. The optical power adjusting tool according to claim 1, wherein the disk drive main body comprises a spindle motor for driving the disc to rotate, and the light sensor is disposed on a lower surface of the frame and is corresponding to a location where the optical pick-up head is farthest from the spindle motor.

8. An optical power adjusting tool movably disposed on a disk drive main body of a DVD recorder to adjust the DVD recorder, the disk drive main body having an optical pick-up head for emitting laser on a disc for recording data, the adjusting tool comprising:
a frame having a first position hole and a second position hole;
a plurality of supporting posts connected on a lower surface of the frame;
a handle disposed on a top surface of the frame for allowing users to hold and grip the optical power adjusting tool easily;
a light sensor disposed on the frame and being opposite to the optical pick-up head when the optical power adjusting tool is disposed on a disk drive main body; and
a conducting wire electrically connected with the light sensor for transmitting an electric signal
wherein the light sensor receives an optical power of the light emitted by the optical pick-up head and produces the electric signal to adjust the DVD recorder according to the electric signal;
wherein a first pillar and a second pillar are formed on both sides of the disk drive main body, and are respectively received within the first position hole and the second position hole when the optical power adjusting tool is movably disposed on the disk drive main body.

9. The optical power adjusting tool according to claim 8, wherein the disk drive main body comprises a spindle motor for driving the disc to rotate, and the light sensor is disposed on a lower surface of the frame and is corresponding to a location where the optical pick-up head is closest to the spindle motor.

10. The optical power adjusting tool according to claim 8, wherein the disk drive main body comprises a spindle motor for driving the disc to rotate, and the light sensor is disposed on a lower surface of the frame and is opposite to a location where the optical pick-up head is farthest from the spindle motor.
